(19) United States
(12) Patent Application Publication
(10) Pub. No.: US 2016/0048571 A1
(43) Pub. Date: Feb. 18, 2016

(54) APPARATUS AND METHODS FOR RELATING INTRA-ORGANIZATION OBJECTS

(71) Applicant: NOKK, New York, NY (US)

(72) Inventor: Robert Davidson, New York, NY (US)

(21) Appl. No.: 14/503,378

(22) Filed: Sep. 30, 2014

Related U.S. Application Data
(60) Provisional application No. 62/038,828, filed on Aug. 18, 2014.

(51) Int. Cl. G06F 17/30

(52) U.S. Cl. CPC G06F 17/30589

(57) ABSTRACT

The present disclosure provides a professional, lite, and fast internal platform for an individual to share a professional profile, role and specialty, and work relationships inside a company for its own use. Furthermore, a user may be able to move beyond simple contact information and be enabled to find co-workers by role, team, or project. Users may be able to find co-workers by specialized focus, affinities, or personal characteristics such as similar hobbies or educational institutions. The platform provides both current and historical data to a company and users in an organized and efficient manner with minimal dedicated resources from the user or company.

### CROSS REFERENCE TO RELATED APPLICATION

This application claims priority to the U.S. Provisional Application 62/038,828 filed Aug. 18, 2014 and entitled APPARATUS AND METHODS FOR RELATING INTRA-ORGANIZATION OBJECTS. The contents of which are relied upon and incorporated by reference.

### FIELD OF THE DISCLOSURE

The present disclosure relates to methods and apparatus for creating hierarchical object or data relationships. More specifically, the present disclosure presents computerized apparatus logically connected and programmed to allow the navigation and discovery of an object's position in an organizational hierarchy as well as the discovery of other objects in the hierarchy.

### BACKGROUND OF THE DISCLOSURE

Traditionally management and organizational hierarchies have been presented via simple graphical display. In some cases, this was done through multi-level charts with a series of rectangles containing an employee's name connected by lines. In some cases, this was done by displaying a pyramid with the leader on the top of the pyramid.

Advancements in this management and organizational hierarchy display have been limited to software to ease the creation of boxes or structures to display an employee.

In some cases, software has been developed to provide an array of services for a small business including human resources, scheduling, time clock, and payroll. In these cases, management and organizational hierarchies have been a peripheral aspect of the software.

The problem is that these traditional management and organizational hierarchies are limited in a number of ways. First, they can be expensive to create and require dedicated and costly personnel for upkeep. Second, they generally only allow employees to find employment title, name of fellow employee, and contact information. Third, small to intermediate business may not have the resources available to create or upkeep these databases. Finally, traditional management and organizational hierarchies have failed to utilize advances in technology and are based the same or similar technology used for decades.

More recently, crowd-sourcing has become a popular method for data collection. Generally, crowd-sourcing information has solicited subjective information to evaluate an object. This information is then used to create a subjective evaluation which may then rank or provide an approval rating for an object. While this new method of data production is valuable in some scenarios such as organization comparison, it has not been applied in the search for objective information about an organization.

### SUMMARY OF THE DISCLOSURE

What is needed is a professional, lite, and fast internal platform for an individual to create and share a professional profile, role and specialty, and work relationships inside a company for its own use. Furthermore, a user may be able to move beyond simple contact information and be enabled to find co-workers by role, team, or project. Users may also be able to find co-workers by specialized focus, affinities, or personal characteristics such as similar hobbies or educational institutions so that they may build the connections and relationships that drive a company's success. Such a system may allow workers to feel more connected to co-workers, part of the company culture, and feel both seen and valued for their contributions to the organization. Such a system may also allow for multiple methods of rewards-based incentives for soliciting a member's input. The results of this inputted information may be displayed to a user graphically or textually.

A professional, lite, and fast internal platform may particularly benefit smaller companies as the platform may require minimal resources from the smaller company. Such a platform may keep employee records for a company while distinguishing between current and former employees as well as their respective specialties and interests. This may both provide an invaluable source of information for companies and also free up resources traditionally dedicated to employee records keeping.

In some embodiments, the present invention comprises an intra-organization object relation system comprising: a communications network access device configured to access a server in logical communication with a digital communications network; and executable software stored on the communications network access device and executable on demand. The software operative with the communications network access device may cause the network access device to receive a navigation prompt from a user, wherein the navigation prompt comprises an indication of interest in a first object profile, and wherein the user is associated with a user object profile; access an object profile database comprising a plurality of object profiles, wherein each of the plurality of object profiles comprises at least one attribute, wherein the at least one attribute comprises at least one quality of a unique object; retrieve the first object profile from the object profile database; compare the user object profile and the first object profile, wherein the comparison determines a logical relationship between the user object profile and the first object profile; and present the object profile to the user, wherein the presentation indicates the logical relationship between the user object profile and the first object profile.

The presentation may comprise an interactive display of the logical relationship, wherein the interactive display comprises a virtual organization ball, wherein the interactive display may enable communication between the user and an object associated with first object profile. In some aspects, the network access device may be further caused to: prompt responsive action from a first user, wherein the responsive action from the first user is responsive to a first query; receive the responsive action from the first user; prompt responsive action from a second user, wherein the responsive action from the second user is responsive to the first query; receive the responsive action from the second user; evaluate the responsive action from the first user and the responsive action from the second user, wherein the evaluation is based on a predefined query; and present a result of the evaluation. In some embodiments, the evaluation may determine if the responsive action from the first user matches the responsive action from the second user.

In some embodiments, the plurality of object profiles comprise one or more of: a personal attribute, wherein the personal attribute comprises a personal quality of the first object; a professional attribute, wherein the professional attribute comprises a professional quality of the first object; and a social attribute, wherein the social attribute comprises a social quality of the first object. In some embodiments, the first object profile may comprise a first professional attribute, wherein the user object profile comprises a user professional attribute, and wherein the comparison is based on a logical relationship between the first professional attribute and the user professional attribute. In some aspects, the first object profile may comprise a first social attribute, wherein the user object profile comprises a user social attribute, and wherein the comparison is based on a logical relationship between the first social attribute and the user social attribute.

In some aspects, an intra-organization object relation system may comprise a communications network access device configured to access a server in logical communication with a digital communications network; and executable software stored on the communications network access device and executable on demand, the software operative with the communications network access device. In some aspects, the software may cause the network access device to: receive one or more attribute of a first object, wherein the one or more attribute comprises one or more quality of the first object; initiate a first object profile for the first object, wherein the first object profile comprises the one or more attribute; access an object profile database comprising a plurality of object profiles, wherein each of the plurality of object profiles comprises at least one attribute, wherein the at least one attribute comprises at least one quality of a unique object; compare the one or more attribute to the plurality of object profiles, wherein the comparison determines a logical relationship with the first object and the unique object of each of the plurality of object profiles; and store the first object profile in the object profile database, wherein a store position is based on the logical relationship.

In some aspects, the one or more attribute may comprise one or more of: a personal attribute, wherein the personal attribute comprises a personal quality of the first object; a professional attribute, wherein the professional attribute comprises a professional quality of the first object; and a social attribute, wherein the social attribute comprises a social quality of the first object. The one or more attribute may comprises one or more of: assign a first identification tag to the first profile.

In some implementations, an intra-organization object relation system may comprise: a communications network access device configured to access a server in logical communication with a digital communications network; and executable software stored on the communications network access device and executable on demand, the software operative with the communications network access device. In some aspects, the software may cause the network access device to: receive a first object profile comprising a first set of attributes, wherein the first set of attributes comprises one or more qualities of a first object; receive a second object profile comprising a second set of attributes, wherein the second set of attributes comprises one or more qualities of a second object; compare the first set of attributes to the second set of attributes; relate logically the first object to the second object, wherein the logical relation is based on the comparison; initiate an object profile database; and store the first object profile and the second object profile, wherein a relative store position is based on the logical relation.

The first set of attributes and the second set of attributes may comprise one or more of: a personal attribute, wherein the personal attribute comprises a personal quality of the first object; a professional attribute, wherein the professional attribute comprises a professional quality of the first object; and a social attribute, wherein the social attribute comprises a social quality of the first object. In some aspects, the one or more attribute comprises one or more of: assign a first identification tag to the first profile.

### BRIEF DESCRIPTION OF THE DRAWINGS

The accompanying drawings, that are incorporated in and constitute a part of this specification, illustrate several embodiments of the disclosure and, together with the description, serve to explain the principles of the disclosure:

FIG. 1A illustrates an excerpt from an exemplary virtual organization ball.

FIG. 1B illustrates an excerpt from an exemplary virtual organization ball.

FIG. 1C illustrates an excerpt from an exemplary virtual organization ball.

FIG. 1D illustrates an excerpt from an exemplary virtual organization ball.

FIG. 2 illustrates an exemplary apparatus that may be used to implement some embodiments of the present invention.

FIG. 3A illustrates exemplary hierarchical inputs.

FIG. 3B illustrates exemplary hierarchical inputs.

FIG. 3C illustrates exemplary hierarchical inputs.

FIG. 4 illustrates an exemplary process for matching object personality profiles.

FIG. 5 illustrates an exemplary process for hierarchy and personality display.

FIG. 6 illustrates an exemplary process for positive identification.

FIG. 7 illustrates a personalized landing page schematic.

FIG. 8 illustrates an exemplary processing and interface system.

FIG. 9 illustrates exemplary splash pages.

FIG. 10 illustrates an exemplary organization exploration type.

FIG. 11 illustrates an alternate exemplary organization exploration type.

FIG. 12 illustrates an alternate exemplary organization exploration type.

FIG. 13 illustrates an alternate exemplary organization exploration type.

### DETAILED DESCRIPTION

The present disclosure provides generally for the methods and apparatus for the creation of hierarchical object or data relationships and the display of these relationships and their associated attributes. According to the present disclosure, a computerized apparatus logically connected and programmed may allow a user to create their own profile within an organization, navigate the organization's hierarchy and discover their position in that organizational hierarchy, discover other objects in the hierarchy, and input user specific information to discover trait relationships with other users. Furthermore, a user may access data from the organization as a whole to determine cultural trends in the organization as well as individual and organizational capabilities.

In the following sections, detailed descriptions of examples and methods of the disclosure will be given. The description of both preferred and alternative examples though thorough are exemplary only, and it is understood that to those skilled in the art that variations, modifications, and alterations may be apparent. It is therefore to be understood that the examples do not limit the broadness of the aspects of the underlying disclosure as defined by the claims.

### GLOSSARY

Identification Tag: as used herein refers to any identifying factor about an object that may be used to determine the unique identity or characteristic of the object. In some embodiments, an identification tag may comprise an attribute of the object profile that may be unique. For example, a unique personal attribute may comprise a name or social security number, or a unique professional attribute may comprise an employee identification number. In some aspects, an identification tag may be a randomly assigned number or alphanumeric series.

Positive Identification: as used herein refers to the result of a process or method used to determine and verify the identity of an object. Positive identification may be used interchangeably with positively identified.

Object: as used herein refers to an employee, project, or other identifying characteristic of an entity that may be placed in a hierarchy.

Object Profile: as used herein refers to an organized collection of information regarding a particular object, wherein the organized collection may comprise one or more of a personal attribute, professional attribute, or social attribute.

Core Questions: as used herein refers to the basic question or questions that may be answered for a user to be placed into a hierarchy, wherein the core question may request information regarding a personal attribute, professional attribute, or social attribute.

Splash Page: as used herein refers to the first page a user may view when accessing a website.

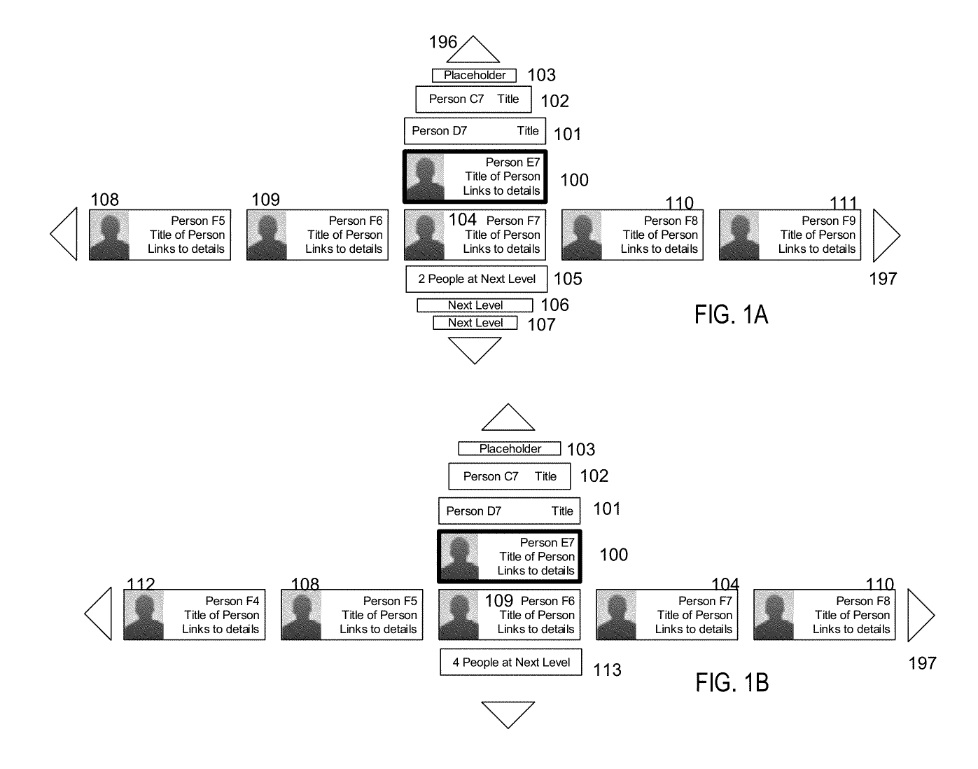

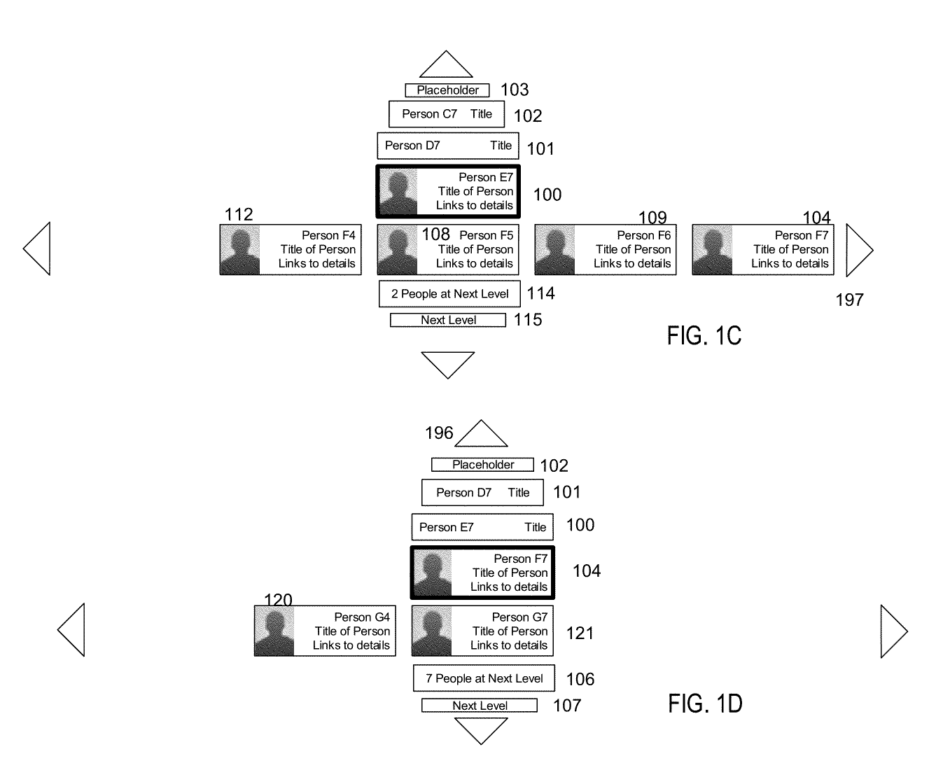

Referring now to FIG. 1A, an exemplary virtual organization ball is illustrated. In some embodiments, focused person position 100 may be a separate color from the other positions in the hierarchy. In some embodiments, other objects in the hierarchy may be navigated to the focused person position 100 where that object would then become the focused object. In some embodiments, there may be first collapsed cell 101, second collapsed cell 102, and third collapsed cell 103 located above the focused person position 100 that may contain information about objects in the hierarchy above the focused person position 100. In some embodiments, left information cell 108, center left information cell 109, center information cell 104, center right information cell 110, and right information cell 111 may contain information about objects that focused person position 100 may have authority over.

In some embodiments, a viewer of the virtual organization ball may navigate between the left information cell 108, center left information cell 109, center information cell 104, center right information cell 110, and right information cell 111 by activating right virtual button 197 depicted in FIG. 1b or left virtual button 199 depicted in FIG. 1d. In some embodiments, navigation using right virtual button 197 or left virtual button 199 may bring into view previously unviewed information cells. In some embodiments, level information 105 may contain information about the number of employees at the same hierarchical level as the center information cell 104 or the number of employees at the hierarchical level below center information cell 104. In some embodiments, first placeholder 106 and second placeholder 107 may contain placeholder information about objects lower in the hierarchy.

Referring now to FIG. 1B, an exemplary virtual organization ball that has been navigated to the left by activating the left virtual button 199 is illustrated. In FIG. 1b level information 105 is no longer visible and has been replaced with new level information 113 that may display information about the number of employees at the same hierarchical level as the center left information cell 109 or the number of employees at the hierarchical level below center left information cell 109. In some embodiments, first placeholder 106 and second placeholder 107 may no longer be visible and may not be replaced because that information is not applicable to center left information cell 109. In some embodiments, a first new information cell 112 may become visible. In some embodiments, right information cell 111 may no longer be visible.

Referring now to FIG. 1C, an exemplary virtual organization ball that has been navigated to the left twice by activating the left virtual button 199 is illustrated. In some embodiments, center right information cell 110 may no longer be visible. In some embodiments, second new level information 114 may display information about the number of employees at the same hierarchical level as the left information cell 108 or the number of employees at the hierarchical level below left information cell 108. In some embodiments, new placeholder 115 may appear to display information about objects lower in the hierarchy.

Referring now to FIG. 1D, an exemplary virtual organization ball that has been navigated to a right end position is illustrated. In some embodiments, center information cell 104 may be navigated to become a focused person. In some embodiments, upward virtual navigation button 196 may allow a user to navigate the virtual organization ball upwards.

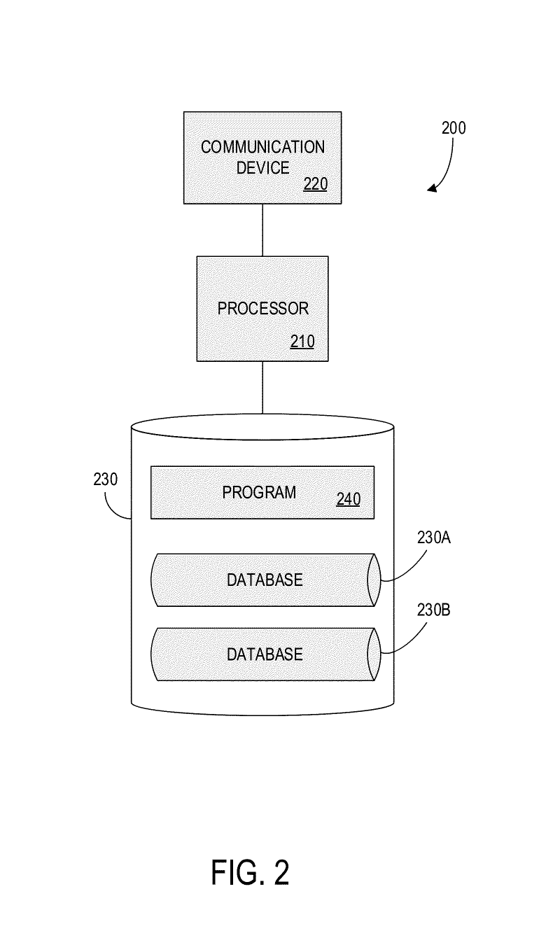

Referring now to FIG. 2, an exemplary apparatus that may be used to implement some embodiments of the present invention is illustrated. More particularly, FIG. 2 illustrates a controller 200 that may be embodied in one or more of the above listed devices and utilized to implement some embodiments of the present invention. The controller 200 comprises a processor unit 210, such as one or more processors, coupled to a communication device 220 configured to communicate via a communication network (not shown in FIG. 2). The communication device 220 may be used to communicate, for example, with one or more online devices, such as a personal computer, laptop or a handheld device.

The processor 210 is also in communication with a storage device 230. The storage device 230 may comprise any appropriate information storage device, including combinations of electronic storage devices, such as, for example, one or more of: hard disk drives, optical storage devices, and semiconductor memory devices such as Random Access Memory (RAM) devices and Read Only Memory (ROM) devices.

The storage device 230 can store a program 240 for controlling the processor 210. The processor 210 performs instructions of the program 240, and thereby operates in accordance with the present invention. The processor 210 may also cause the communication device 220 to transmit information, including, in some instances, control commands to operate apparatus to implement the processes described above. The storage device 230 can additionally store related data in a database 230A and database 230B, as needed.

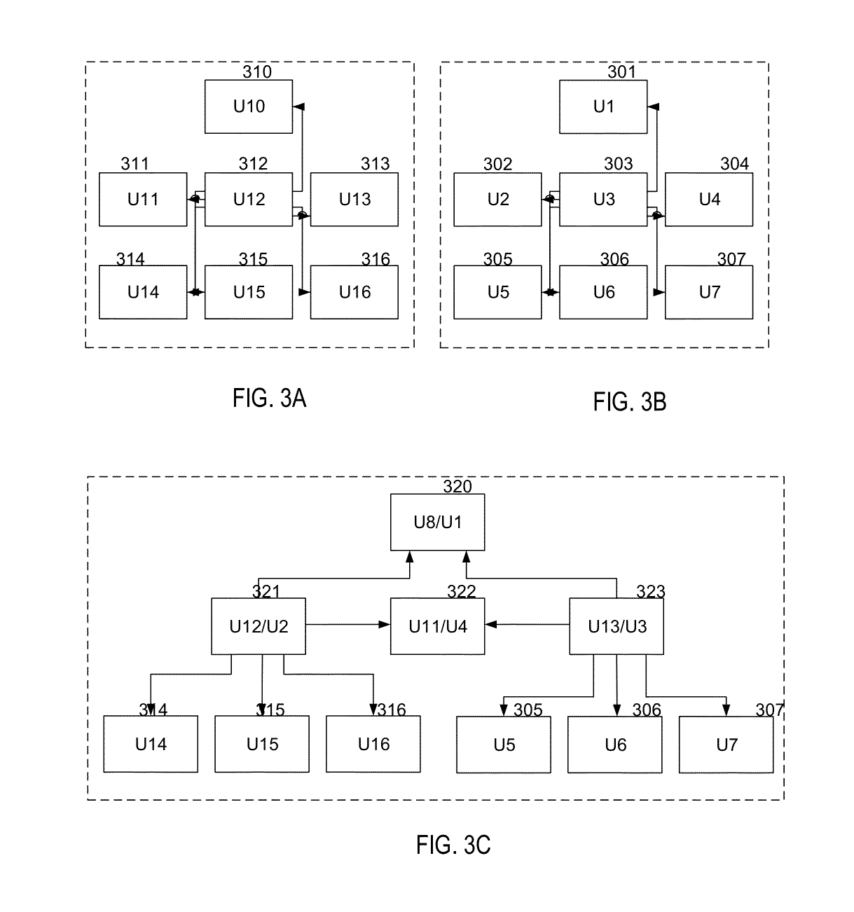

Referring now to FIGS. 3A-3C, exemplary hierarchical inputs are illustrated. Referring now to FIG. 3A, a user input is illustrated. In some embodiments, User Twelve 312 may input information about co-workers or peers User Eleven 311 and User Thirteen 313. In some embodiments, User Twelve 312 may input information about subordinate employees User Fourteen 314, User Fifteen 315, and User Sixteen 316. In some embodiments, User Twelve 312 may input information about supervisors such as User Ten 310.

Referring now to FIG. 3B, a second user input is illustrated. In some embodiments, User Three 303 may input information about co-workers or peers User Two 302 and User Four 304. Additionally, User Three 303 may input information about subordinate employees User Five 305, User Six 306, and User Seven 307. In some embodiments, User Three 303 may input information about supervisor User One 301.

Referring now to FIG. 3C, a combined user hierarchy is illustrated. In some embodiments, one or all a method, process, or application may determine from data inputted by User Twelve 312 about User Ten 310 and from data inputted by User Three 303 about User One 301 that User Ten/User One 320 have the same identification tag and therefore may be the same user. In some embodiments, one or all a method, process, or application may determine from data inputted by User Twelve 312 about User Three 303 and from data inputted by User Three 303 about User Twelve 312 that because each user mutually identified the other user as a coworker or peer, that they may be placed on the same hierarchy level. In some embodiments, User Twelve 312 may input information about User Eleven 311 identifying 311 as a coworker and User Three 303 may input information about User Four 304 identifying 304 as a coworker.

This information may be used to determine that these separately identified users are the same user 322. In some embodiments, the combined hierarchy may show the combined subordinate employees of separate users. This is illustrated by 314, 315, and 316 under 321 as well as 305, 306, 307 under 323. This pattern of mutual positive identification or some other method of positive identification may continue throughout the combined hierarchy to determine that where identified users have the same identification tag from separate sources, that user may be determined the same user.

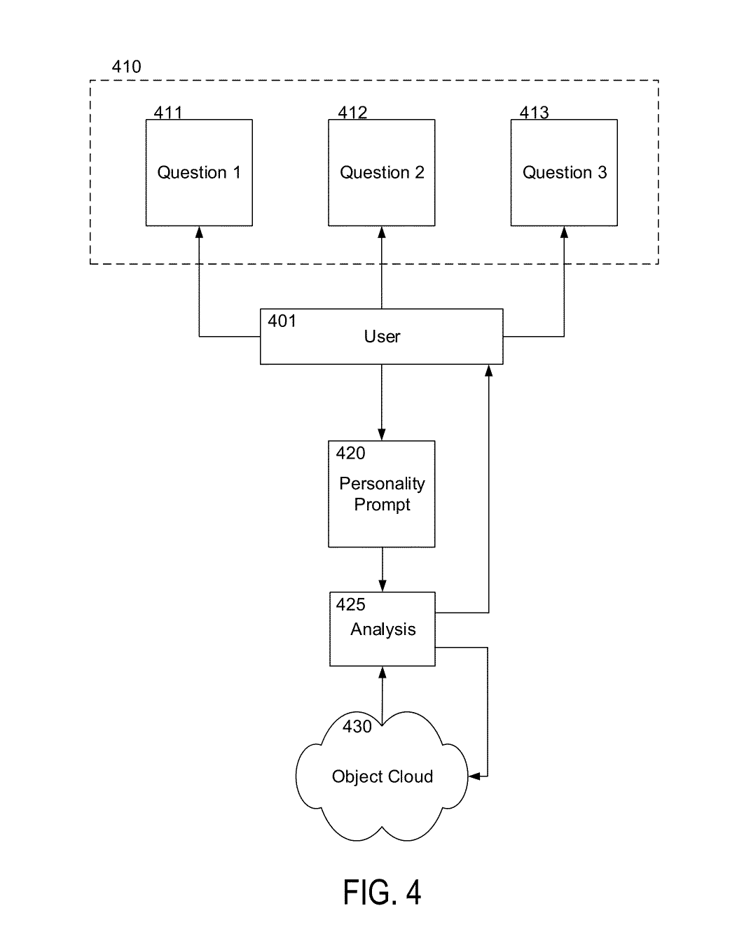

Referring now to FIG. 4, an exemplary process for matching object personality profiles is illustrated. In some embodiments, User 401 may answer a core question or a series of core questions 410 which may enable the user to be placed into a hierarchy. In some embodiments, question 1 411, question 2 412, and question 3 413 may be questions that place a user in a combined hierarchy such as illustrated and described in FIG. 3C.

User 401 may also receive a prompt to input information that may provide a personality identification tag. This personality identification tag, the result of prompt 420, may be used for analysis 425 with Object Cloud 430. Analysis 425 may be done through algorithms, direct comparison, or other methods of processing to determine relationships in the personality identification tag. In some embodiments, analysis 425 may result in information sent to user 401 or object cloud 430. In some embodiments, information may be sent to both user 401 and object cloud 430. In some embodiments, object cloud 430 may contain information gathered from other users. In some embodiments, object cloud 430 may contain information from one or more the same prompt 420, a similar prompt, or a category of information.

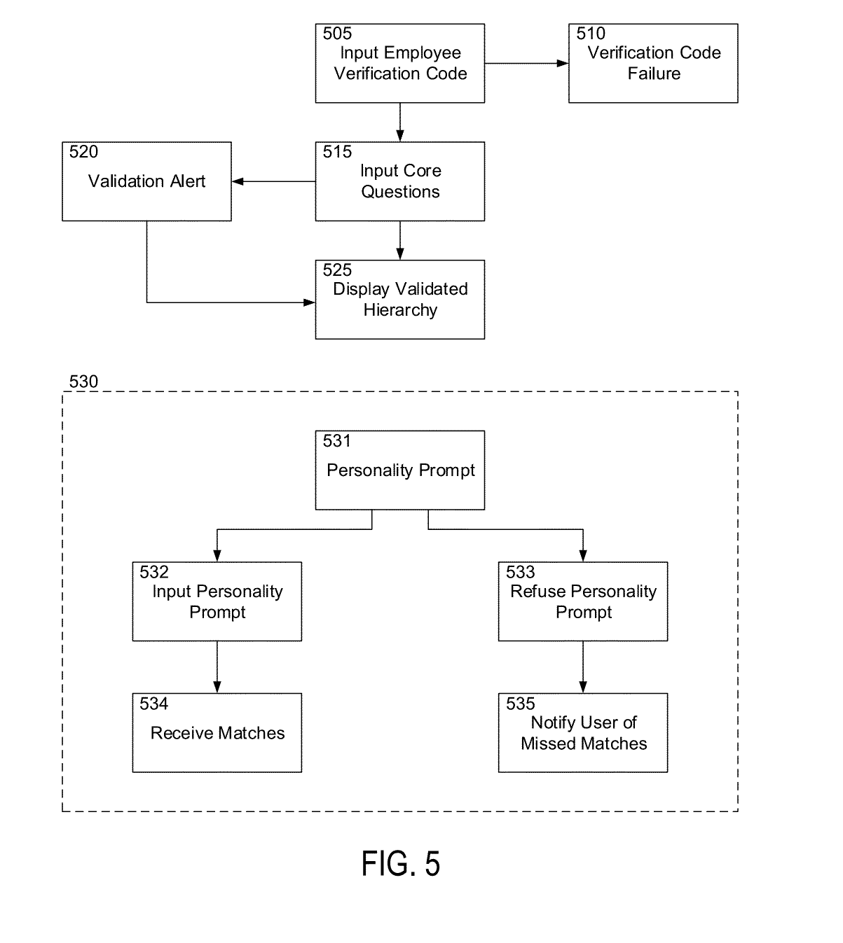

Referring now to FIG. 5, an exemplary process for hierarchy and personality display is illustrated. In some embodiments, a verification code 505 may be required to allow a user to begin to use the organizational hierarchy. In some embodiments, verification code 505 may be company specific and ensure that a user is both authorized and inputting information into the correct hierarchy. In some embodiments, a failure notification 510 may notify a user that an incorrect code has been given. In some embodiments, a failure notification 510 may trigger a separate message to an authorized user. As an illustrative example, a new user may input an incorrect code and as a result a designated employee may receive an email notification that the new user has inputted an incorrect code.

In some embodiments, a user may input core questions 515. In some embodiments, a user may input core questions 515 and receive a validation notification 520 alerting a user that their hierarchy may need validation. In some embodiments, validation notification 520 may also send an email or other means of notification to a separate user seeking positive identification of the relationship. After the user receives validation notification 520, the validated hierarchy display 525 will display to the user. Validated hierarchy display 525 may consist of relationships that have been positively identified.

In some embodiments, optional personality set 530 may occur at any point in the process illustrated by FIG. 5A. In some embodiments, optional personality set 530 may include personality prompt 531, which may include any prompt designed to gather information about a user's personality. In some embodiments, a user may input personality information 532 in response to personality prompt 531 and receive matches 534. In some embodiments, a user may refuse personality prompt 533 and in response receive opt out prompt 535, which may notify the user of the missed opportunity to be matched to other employees and the steps to receive another personality prompt 531.

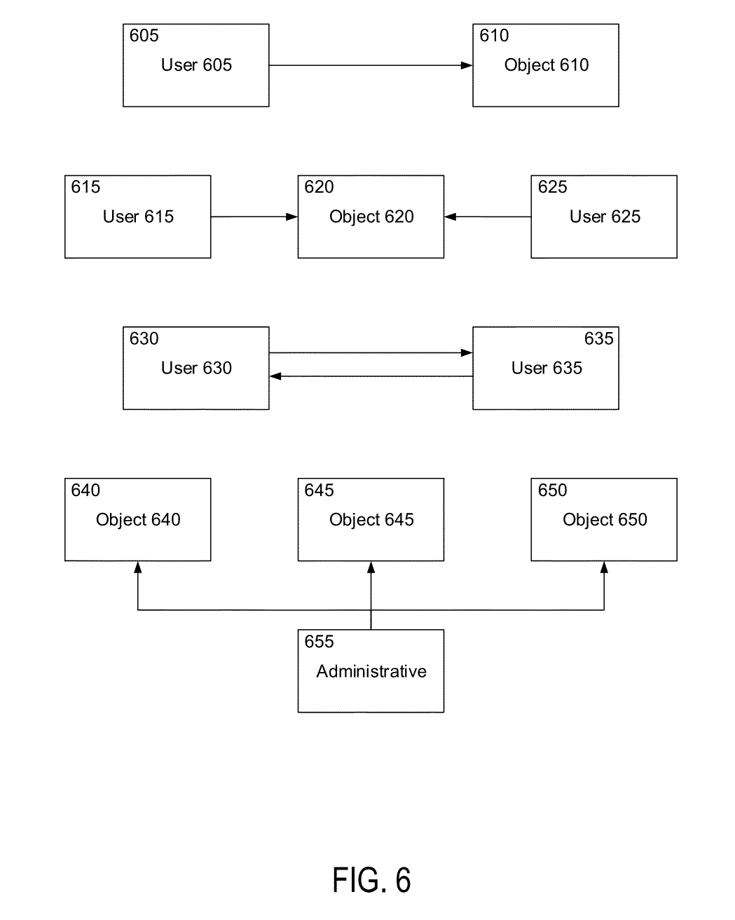

Referring now to FIG. 6, exemplary processes for positive identification are illustrated. In some embodiments, positive identification may be accomplished by a user 605 defining an object 610. In some embodiments, user 605 may be restricted from positively identifying object 610 without further verification. In some embodiments, user 605 may be allowed to positively identify object 610 if user 605 has previously been positively identified. In some embodiments, user 605 may be allowed to positively identify object 610 if user 605 has reached a pre-determined status after correctly defining a pre-determined number of objects. In some embodiments, user 605 may be allowed to positively identify an object if an object is in a subordinate position on a hierarchy.

In some embodiments, User 615 may identify object 620. Concurrently or afterwards user 625 may also identify object 620. In some embodiments, positive identification may not occur after User 615 identification but may only occur after User 625 identification. In some embodiments, an additional step for positive identification may be required.

In some embodiments, User 630 may identify User 635. Concurrently or afterwards User 635 may identify User 630. In some embodiments, positive identification may not occur after the User 630 identification but may only occur after the reciprocated identification from User 635. As an illustrative example, a supervisor may identify a subordinate employee. At this point, neither the supervisor nor the subordinate would be positively identified in the organization hierarchy. However, when the subordinate employee validates the relationship identified by the supervisor, one or both of their positions on the organization hierarchy may be successfully positive identified.

In some embodiments, an Administrative User 655 may be authorized to positively identify objects. In some embodiments, Administrative User 655 may positively identify Object 640, Object 645, and Object 650 without need for any further verification. As an illustrative example, an employee within a company may be authorized by management to identify users or audit users and therefore have the power to identify users without need for further positive identification. Therefore, the employee may define the position of president of the company as John Smith and restrict the title of president to only John Smith. As a result, regardless of how many users identify a different object as president, the hierarchy may only show John Smith as the sole president.

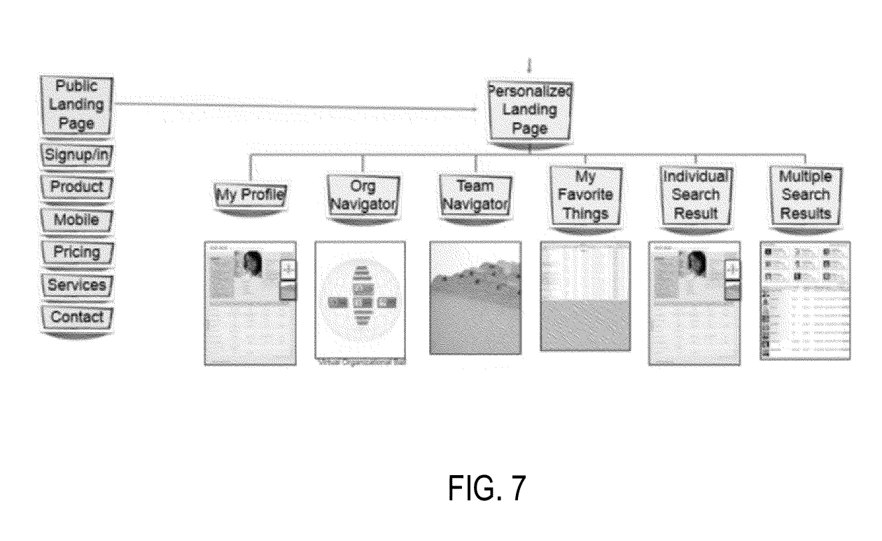

Referring now to FIG. 7, a personalized landing page schematic is depicted. In some embodiments, a user may create a customized home page, which may present preferred links. As illustrated, the user may be able to navigate to his profile, the organization navigator, team navigator, my favorite things, individual search results, and multiple search results. For example, a team navigator may comprise details and hierarchal relationships for objects within a team, in contrast to an organization navigator, which may comprise hierarchal relationships for an entire organization. The “my favorite things” tab may list answers a user may have provided for personality questions and/or preferences extracted from navigation, search, and activity behavior on an access device. In some embodiments, a user may be able to search for details related to a particular individual. A user may be able to search the team and/or organization for individuals who may fit search criteria, such as relationship to a particular object or personality answers.

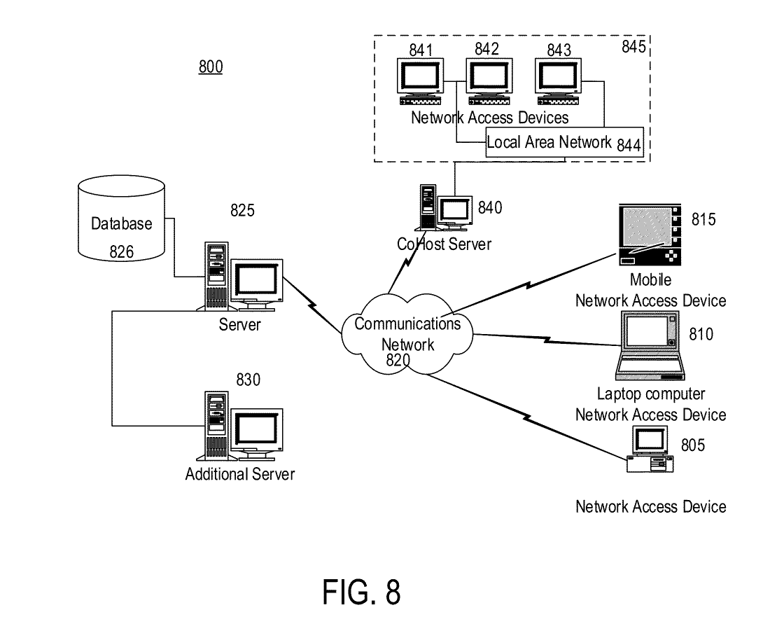

Referring now to FIG. 8, an exemplary processing and interface system 800 is illustrated. In some aspects, access devices 815, 810, 805, such as a mobile device 815 or laptop computer 810 may be able to communicate with an external server 825 though a communications network 820. The external server 825 may be in logical communication with a database 826, which may comprise data related to identification information and associated profile information. In some examples, the server 825 may be in logical communication with an additional server 830, which may comprise supplemental processing capabilities.

In some aspects, the server 825 and access devices 805, 810, 815 may be able to communicate with a cohost server 840 through a communications network 820. The cohost server 840 may be in logical communication with an internal network 845 comprising network access devices 841, 842, 843 and a local area network 844. For example, the cohost server 840 may comprise a social network such as Linkedin or Facebook.

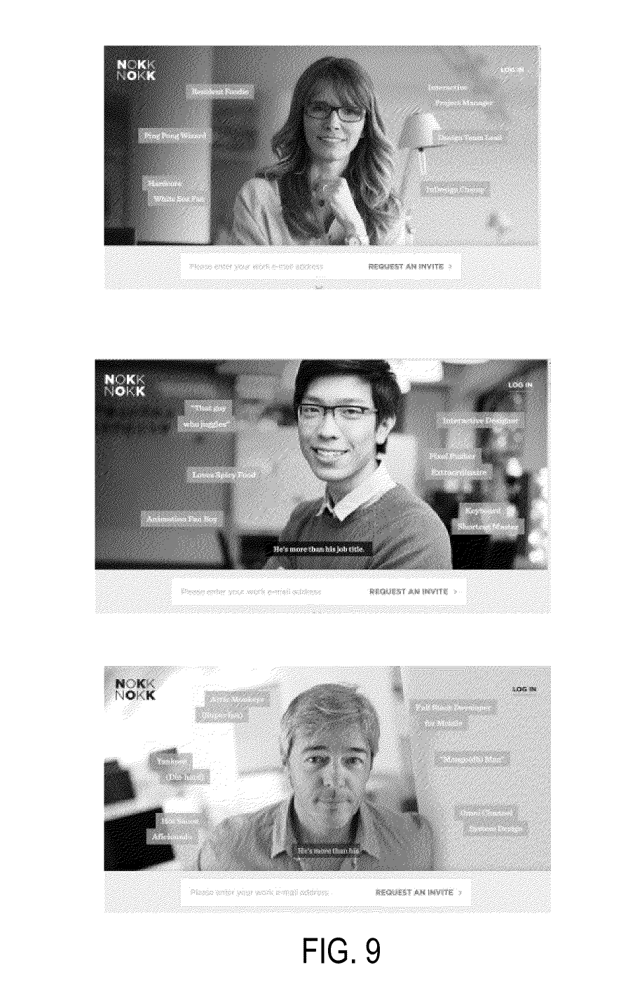

Referring now to FIG. 9, exemplary splash pages are shown. The splash pages may offer a brief visual description showing some of the aspects of the invention. In some embodiments, the splash page may provide a section for a user to log-in. In some embodiments, the splash pages may cycle through a sample series of object profiles, wherein a user may click on the splash page to further interact with the object profiles displayed. In some aspects, where a user may be logged in, the splash pages may be customized further based on the object profile, settings, and permissions associated with the user.

In some embodiments, the splash page may comprise the same or similar layout as an object profile. In some aspects, a user may be able to customize how and what attributes may be presented from an object profile. For example, a user may be interested in an object profile on a personal and social level and may elect to only display personal and social attributes. Alternately, a user may be interested in an object profile on a professional level and may elect to hide personal and social attributes. In some aspects, a user may be limited to viewing specific attributes or attribute types based on authorization level.

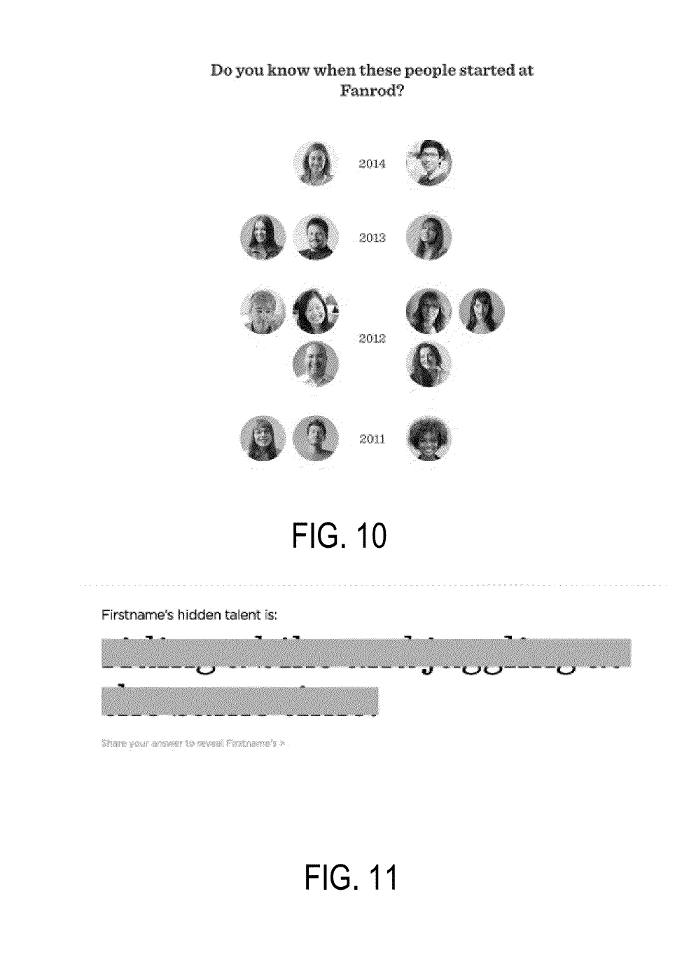

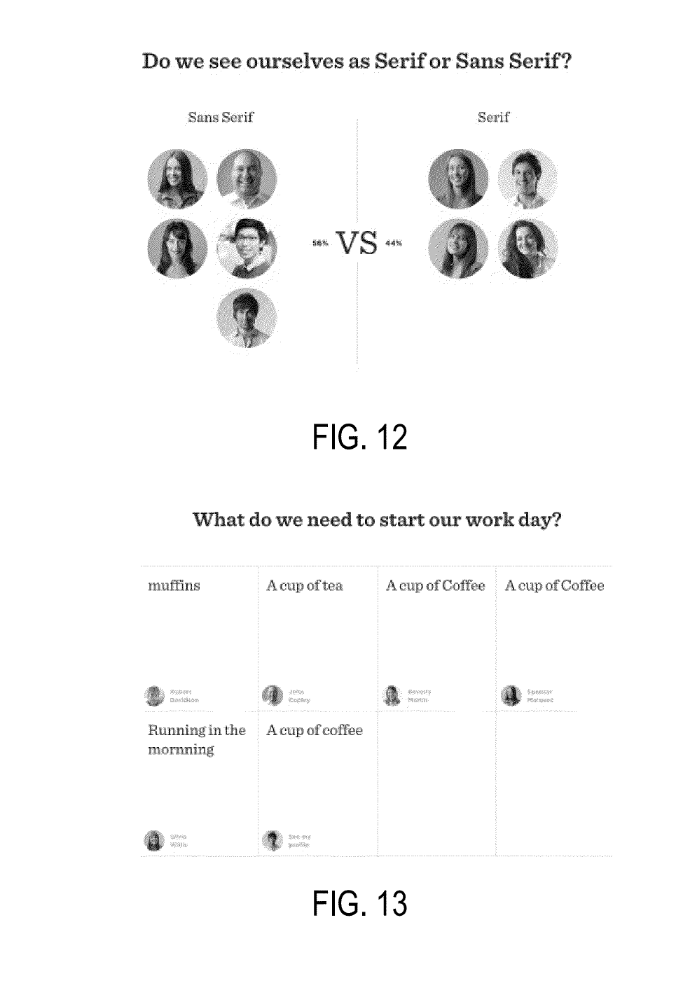

Referring now to FIGS. 10-13, exemplary exploration types are illustrated. As illustrated in FIG. 12, in some embodiments, a user may explore the other objects in the organization, and may be presented with attributes from other object profiles. For example, a user may be presented with start date information. A user may click on an image associated with an object profile to further explore the object profile.

As illustrated in FIG. 11, in some embodiments, the user may be visually or textually prompted with a question regarding information that may be missing or needs to be verified. In some embodiments, a user may submit information in order to receive a reward. In some embodiments, a reward may entail a graphic change that may display previously restricted information. In some embodiments, this graphic change may be in the form of a yellow tape that may previously covered text being removed so the text becomes visible. In some embodiments, the data displayed may pertain to shared answers from the same questions answered by single or multiple users. In some embodiments, information with divergent answers may be displayed and compared visually or textually in real time. In some embodiments, information with similar or the same answers may be displayed and compared visually or textually in real time.

In some embodiments, data display may be accomplished through one or more text or data. As illustrated in FIG. 12, in some embodiments, data display may be visualized using a graphic representation of a profile to illustrate connections, similarities, or differences between objects. As illustrated in FIG. 13, in some embodiments, data display may be displayed according to shared or separate temporal values.

In some aspects, exploration options may allow a user to dynamically interact with the virtual organization ball, wherein the user may explore object profiles based on personal attributes, professional attributes, or social attributes. For example, an exploration type may comprise a simple text search, wherein a user may type in a name associated with an object profile. In some embodiments, an exploration type may allow a user to search for object profiles that may have social attributes in common, such as hobbies or favorite football team. In some aspects, such as illustrated in FIGS. 1A-1D, an exploration option may allow a user to navigate the virtual organization ball based on professional attributes, such as hierarchy or division.

### CONCLUSION

A number of embodiments of the present disclosure have been described. While this specification contains many specific implementation details, there should not be construed as limitations on the scope of any disclosures or of what may be claimed, but rather as descriptions of features specific to particular embodiments of the present disclosure.

Certain features that are described in this specification in the context of separate embodiments can also be implemented in combination in a single embodiment. Conversely, various features that are described in the context of a single embodiment can also be implemented in combination in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous.

Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order show, or sequential order, to achieve desirable results. In certain implementations, multitasking and parallel processing may be advantageous. Nevertheless, it will be understood that various modifications may be made without departing from the spirit and scope of the claimed disclosure.

What is claimed is:

1. An intra-organization object relation system comprising:
a communications network access device configured to access a server in logical communication with a digital communications network; and
executable software stored on the communications network access device and executable on demand, the software operative with the communications network access device to cause the network access device to:
receive a navigation prompt from a user, wherein the navigation prompt comprises an indication of interest in a first object profile, and wherein the user is associated with a user object profile;
access an object profile database comprising a plurality of object profiles, wherein each of the plurality of object profiles comprises at least one attribute, wherein the at least one attribute comprises at least one quality of a unique object;
retrieve the first object profile from the object profile database;
compare the user object profile and the first object profile, wherein the comparison determines a logical relationship between the user object profile and the first object profile; and
present the object profile to the user, wherein the presentation indicates the logical relationship between the user object profile and the first object profile.

2. The intra-organization object relation system of claim 1 wherein the presentation comprises in an interactive display of the logical relationship, wherein the interactive display comprises a virtual organization ball.

3. The intra-organization object relation system of claim 2, wherein the interactive display enables communication between the user and an object associated with first object profile.

4. The intra-organization object relation system of claim 1, wherein the network access device is further caused to:
prompt responsive action from a first user, wherein the responsive action from the first user is responsive to a first query;
receive the responsive action from the first user;
prompt responsive action from a second user, wherein the responsive action from the second user is responsive to the first query;
receive the responsive action from the second user;
evaluate the responsive action from the first user and the responsive action from the second user, wherein the evaluation is based on a predefined query; and
present a result of the evaluation.

5. The intra-organization object relation system of claim 4, wherein the evaluation determines if the responsive action from the first user matches the responsive action from the second user.

6. The intra-organization object relation system of claim 1, wherein the plurality of object profiles comprise one or more of:
a personal attribute, wherein the personal attribute comprises a personal quality of the first object;
a professional attribute, wherein the professional attribute comprises a professional quality of the first object; and
a social attribute, wherein the social attribute comprises a social quality of the first object.

7. The intra-organization object relation system of claim 6, wherein first object profile comprises a first professional attribute, wherein the user object profile comprises a user professional attribute, and wherein the comparison is based on a logical relationship between the first professional attribute and the user professional attribute.

8. The intra-organization object relation system of claim 6, wherein first object profile comprises a first social attribute, wherein the user object profile comprises a user social attribute, and wherein the comparison is based on a logical relationship between the first social attribute and the user social attribute.

9. An intra-organization object relation system comprising:
a communications network access device configured to access a server in logical communication with a digital communications network; and
executable software stored on the communications network access device and executable on demand, the software operative with the communications network access device to cause the network access device to:
receive one or more attribute of a first object, wherein the one or more attribute comprises one or more quality of the first object;
initiate a first object profile for the first object, wherein the first object profile comprises the one or more attribute;
access an object profile database comprising a plurality of object profiles, wherein each of the plurality of object profiles comprises at least one attribute, wherein the at least one attribute comprises at least one quality of a unique object;
compare the one or more attribute to the plurality of object profiles, wherein the comparison determines a logical relationship with the first object and the unique object of each of the plurality of object profiles; and
store the first object profile in the object profile database, wherein a store position is based on the logical relationship.

10. The intra-organization object relation system of claim 9, wherein the one or more attribute comprises one or more of:
a personal attribute, wherein the personal attribute comprises a personal quality of the first object;
a professional attribute, wherein the professional attribute comprises a professional quality of the first object; and
a social attribute, wherein the social attribute comprises a social quality of the first object.

11. The intra-organization object relation system of claim 9, wherein the one or more attribute comprises one or more of:
assign a first identification tag to the first profile.

12. An intra-organization object relation system comprising:
a communications network access device configured to access a server in logical communication with a digital communications network; and
executable software stored on the communications network access device and executable on demand, the software operative with the communications network access device to cause the network access device to:
receive a first object profile comprising a first set of attributes, wherein the first set of attributes comprises one or more qualities of a first object;
receive a second object profile comprising a second set of attributes, wherein the second set of attributes comprises one or more qualities of a second object;
compare the first set of attributes to the second set of attributes;
relate logically the first object to the second object, wherein the logical relation is based on the comparison;
initiate an object profile database; and
store the first object profile and the second object profile, wherein a relative store position is based on the logical relation.

13. The intra-organization object relation system of claim 12, wherein the first set of attributes and the second set of attributes comprises one or more of:
a personal attribute, wherein the personal attribute comprises a personal quality of the first object;
a professional attribute, wherein the professional attribute comprises a professional quality of the first object; and
a social attribute, wherein the social attribute comprises a social quality of the first object.

14. The intra-organization object relation system of claim 12, wherein the one or more attribute comprises one or more of:
assign a first identification tag to the first profile.
